(19) United States
(12) Patent Application Publication
(10) Pub. No.: US 2007/0000142 A1
(43) Pub. Date: Jan. 4, 2007

(54) System for Removing Wrinkles Using a Conventional Dryer

(76) Inventors: Richard A Breese, Witchita, KS (US); Tim Diasti, Clearwater, FL (US)

Correspondence Address: SMITH HOPEN, PA, 180 PINE AVENUE NORTH, OLDSMAR, FL, 34677, US

(21) Appl. No.: 11/164,302

(22) Filed: Nov. 17, 2005

Related U.S. Application Data
(63) Continuation of application No. 60/595,417, filed on Jul. 1, 2005.

(51) Int. Cl. F26B 19/00; F26B 11/02

(52) U.S. Cl. 34/60; 34/597

(57) ABSTRACT

This invention pertains to systems and methods for removing wrinkles in apparel and other fabrics using a conventional dryer. The system utilizes a fluid-dispensing container, or “dryer ball”. The dryer ball is included with the articles of clothing during the dryer cycle. During the agitation of the dryer cycle the dryer ball will release a fluid contained therein. In certain aspects of the invention the dryer ball will be a substantially spherical receptacle containing a fluid or fluid-like substance. The fluid will be released in a temporal fashion during the dryer cycle. The combined action of the ball and the released fluid during the dryer cycle facilitates the removal of wrinkles from fabric.

### CROSS-REFERENCE TO RELATED APPLICATIONS

This application claims priority to U.S. Provisional Patent Application No. 60/595,417, filed Jul. 1, 2005, the contents of which are herein incorporated by reference.

### FIELD OF INVENTION

This invention pertains to systems and methods for the care of articles of clothing, fabric, linens and the like. More specifically, this invention pertains to systems and methods for removing wrinkles in apparel and other fabrics using a conventional dryer.

### BACKGROUND OF INVENTION

There is considerable interest in laundering and care of apparel, lines and other fabrics. During the processes of wearing and cleaning these articles tend to become wrinkled. A wrinkled appearance is highly undesirable. As a consequence, great amounts of time and effort are spent ironing and pressing items such as apparel, bedding and other items of fabric. Also, a great deal of money is spent by individuals to have their clothing professionally cleaned to save the time and effort associated with removing wrinkles. What is needed is a system and associated methods to simplify the process of wrinkle-removal from fabrics where the fabrics can be run through a conventional dryer. The instant invention serves this important purpose.

Dispensers for fabric softeners are known in the art. These devices have as their objects the reduction of static cling and the imparting of scents and a soft feel to fabrics. One such device is taught in U.S. Pat. No. 6,574,883 B2 ('883) by Giblin et al. The '883 patent teaches a dispenser for laundry products, particularly for fabric softener products to be used in the dryer. The dispenser is a hollow ball having a plurality of product dispensing openings arranged across the surface of the ball and a product ingress opening at the top for placing product in the ball. A measuring cup sits inside the ball to hold product inside during filling. The cup is accessed from the product ingress opening. The measuring cup includes an opening in its side wall near the upper limit of the measuring cup for releasing product from the cup and into the hollow sphere when the sphere is tumbled by the action of the dryer. Thus, the measuring cup prevents the premature release of product through the plurality of product dispensing openings arranged across the surface of the ball. After travelling through the small hole in the cup, the product is dispensed to the exterior of the hollow ball through the product dispensing openings and thus onto product.

Silicone-based products have been used to facilitate the ironing of clothing using a convention iron. U.S. Pat. No. 5,064,543 to Coffindaffer et al. teaches a fabric care composition comprising a silcone gel for ease of ironing and improved appearance after ironing. U.S. Pat. No. 6,495,057 B1 to Kasson et al. teaches a composition containing water, alcohol and a silicone surfactant containing at least one polyether substituent group per molecule that has wrinkle-reducing properties.

Other patents and applications for patents disclosing fabric softener or other devices include Hagemann et al., Pub. No. US2003/0213145A1, Birllaud et al., U.S. Pat. No. 3,706,140, Bolan et al., U.S. Pat. No. 4,304,562, Anderson, U.S. Pat. No. 5,966,831, Furgal et al., U.S. Pat. No. 4,014,105, Sachs, U.S. Pat. No. 4,532,722, Cobb, U.S. Pat. No. 2,941,309 Cornette et al., U.S. Pat. No. 4,703,872, Falivene, U.S. Pat. No. 4,057,673, Kunzel et al., U.S. Pat. No. 4,183,981, Roy, U.S. Pat. No. 5,040,311, Rennie, U.S. Pat. No. 4,567,675, Davies, U.S. Pat. No. 4,532,719, Vesborg, U.S. Pat. No. 4,893,726 and D'Hoogue et al., U.S. Pat. No. 4,875,600.

### SUMMARY OF INVENTION

This invention pertains to systems and methods for removing or decreasing wrinkles in apparel and other fabrics using a conventional dryer. The system utilizes a fluid-dispensing container, or “dryer ball”. The dryer ball is included with the articles of clothing during the dryer cycle. During the agitation of the dryer cycle the dryer ball will release a fluid contained therein. In certain aspects of the invention the dryer ball will be a substantially spherical receptacle containing a fluid or fluid-like substance. The fluid will be released in a temporal fashion during the dryer cycle. The combined action of the ball and the released fluid during the dryer cycle facilitates the removal of wrinkles from fabric.

This invention also provides for a method of treating a wrinkled fabric to reduce the amount of wrinkling, comprising contacting the fabric with an effective amount of a composition comprising water, alcohol and a silicone surfactant, wherein the effective amount is released by a dryer ball in response to the action of a tumble dryer.

### BRIEF DESCRIPTION OF THE DRAWINGS

For a fuller understanding of the nature and objects of the invention, reference should be made to the following detailed description, taken in connection with the accompanying drawings, in which:

FIG. 1 is an illustration of an elevation view of one embodiment of a dryer ball according to the invention.

FIG. 2 is an illustration of an elevation view of another embodiment of a dryer ball depicting the receptacle of the dryer ball without a closure. The figure also illustrates the addition of a fill line to the side of the receptacle.

FIG. 3 is an illustration of an elevation view of the closure of the receptacle shown in cut-away depicting the product dispensing openings passing through the surface of the closure.

FIG. 4 is an illustration of a top plan view of the closure.

### DETAILED DESCRIPTION OF THE PREFERRED EMBODIMENT

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

A system and associated methods removing wrinkles in apparel and other fabrics using a conventional dryer is disclosed herein. The system includes a dryer ball and a fluid, or fluid-like substance, that is included with linens and apparel during the dryer cycle. The present invention further includes methods for removing wrinkles in a conventional dryer, said method including the steps of placing the dryer ball in a dryer with clothes in need of wrinkle-removal and activating the dryer cycle.

As used herein, the term “fabric” is used broadly and includes woven and non-woven textiles made from natural fibers, such as for example, cotton, silk, linen or wool, man made fibers, such as for example, polyester, rayon or nylon, or combinations thereof, as well as garments or other articles, for example, window draperies, made form such materials. In a preferred embodiment, the fabric is a woven textile comprising at least one natural fiber. In a highly preferred embodiment, the fabric comprises, a garment made from a woven textile comprising at least one natural fiber.

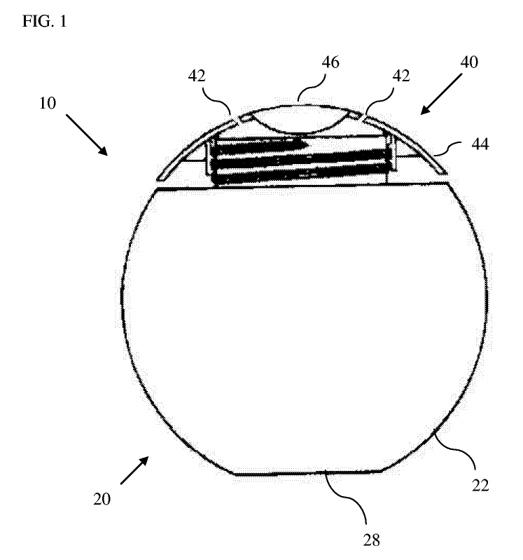

FIG. 1 shows an embodiment of a dryer ball according to the invention. The exemplary dryer ball 10 has a substantially spherical shape formed from a receptacle 20 and a closure 40. As used herein, the term “receptacle” refers to a container that holds items or matter, or more particularly, a container that holds fabric conditioning or treating substances. The outer surface 44 of the closure 40 and the outer surface 22 of the receptacle 20 are rounded and form a single, continuous, substantially spherical surface when the closure is engaged on the receptacle. The receptacle 20 has solid walls 22 and a hollow interior. The receptacle 20 is designed to contain a fluid or fluid-like substance. It is found to be advantageous to have a flat bottom 28 on the receptacle to keep the receptacle upright while filling the ball with a fluid. The flat bottom also prevents the ball from rolling when the ball is being stored during non-use.

A substantially spherical shape for the dryer ball 10 is found particularly advantageous. This shape facilitates movement of the ball through clothing or other fabrics as a result of the tumbling action of the dryer, while minimizing unwanted interactions with clothing. The rounded shape also results in less noise when the object encounters the inner walls of the dryer during the dryer cycle. Other configurations and shapes are possible without deviating from the spirit of the invention. These can include egg-shaped receptacles, ovoid-shaped receptacles, cylindrical-shaped receptacles and the like.

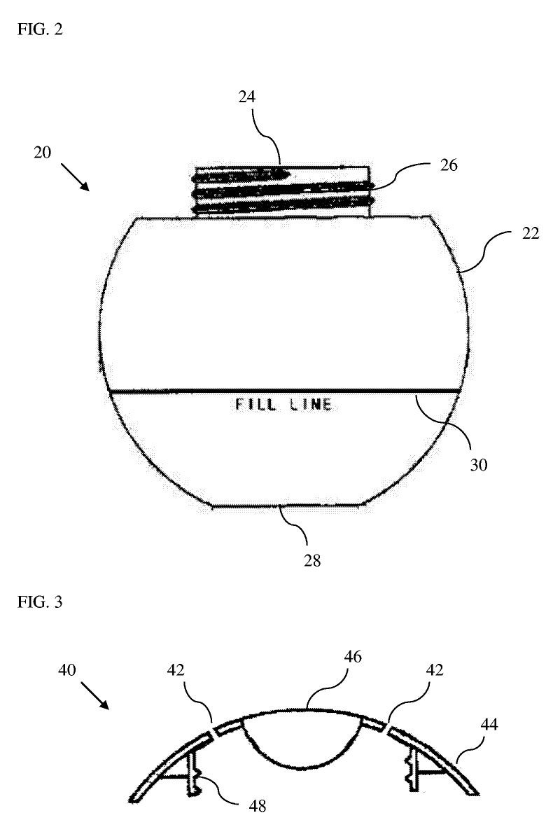

FIG. 2 shows another embodiment of the receptacle 20 of the dryer ball according to the invention. The receptacle has a product ingress opening 24 at the top of the receptacle to facilitate the addition of wrinkle-reducing solution or other fabric care products when the closure 40 of the dryer ball is removed. The exemplary embodiment utilizes a threaded opening 26 to engage the complementary structure 48 on the closure 40. The receptacle may be made of various plastic materials such as polyethylene, polypropylene, or polypropylene copolymer. Low density polyethylene is a particularly advantageous material for the receptacle due to its inherent ductility and low reactivity with a variety of solutions. By employing a material that can easily sustain elastic deformations, the noise created at impact with the side of the dryer during tumbling is further minimized. It is found advantageous to construct the ball from a translucent material to facilitate viewing of the product level inside the ball during the operation of filling. Further, where the ball has a bright color, such as a translucent red, the ball may be more easily visualized amongst clothing or other fabrics. The ball can also include one or more lines or demarcations on its surface indicating desirable fill amounts for an application.

FIG. 3 shows the closure 40 of the dryer ball depicted in FIG. 1. The closure is shown in a cut-away view to illustrate the product dispensing openings 42, or product dispensing holes, in the surface 44 of the closure. When the closure 40 is affixed to the top of the receptacle 20 the product dispensing holes 42 enable open communication between the hollow space in the interior of the dryer ball and the exterior environment. By product dispensing openings it is meant an opening adapted to facilitate the egress of the fabric conditioning or treating substance from the receptacle during operation of the dryer. It is found advantageous to have the receptacle surface free of the ball dispensing openings to thereby prevent egress, or more generally termed “leakage,” of the fabric conditioning substance during filling and other preparation of a dryer cycle prior to the ball's action during the cycle. Often, fabric conditioning or treating substances are in a liquid or gel form. Where the receptacle itself has dispensing openings on its surface, the fabric conditioning or treating substances will tend to leak or spill out of the receptacle during filling. By localizing the dispensing openings to the closure, the receptacle can be filled to capacity while retaining the substance contained therein. Thus, these product dispensing holes 42 allow for the temporal release of the fluid contained within the dryer ball 10 during the operation of the dryer cycle. By optimizing the size of the product dispensing holes for the viscosity of the particular fabric conditioning solution a mist can be achieved which sufficiently coats fabrics resulting in the desired wrinkle reducing attributes imparted to the fabric during the dryer cycle. Holes having a diameter of about 0.39 mm were found to be optimal for solution comprising by volume 90% purified water, 10% N-propyl alcohol, 0.002% silicone surfactant and 0.001% quarternary amine with trace volume of fragrance. It is found that localizing the holes for product release in the closure of the dryer ball is particularly advantageous. Dryer balls having holes located about the surface of the receptacle are characterized by the premature release of fabric conditioning solution, especially as the level of the fluid within the receptacle exceeds the height of a product dispensing hole 42. When the holes are in the closure, the ball may be filled to a high level without fluid leaking out. Additionally, fluid is much less likely to be lost upon transition from filling into the dryer. It should be understood that other configurations of holes or mechanisms of release are also contemplated in the present invention. For instance, the closure surface 44 of the closure 40 could be constructed of a porous material that allows for the temporal egress of fluid during the action of the dryer cycle. The closure 40 further includes a grip tab 46 for grasping between the fingers of a user to facilitate twisting the closure on and off of the receptacle for filling. The closure 40 includes a tab 46, or grasp, to facilitate rotation of the closure 40 during the operations of removing and replacing the closure 40 during the process of adding fluid to the dryer ball 10. The product dispensing holes 42 are situated in a medial position relative to the threads 48 and proximal to the tab 46. The location of the tabs in this proximal position enables the open communication of the receptacle with the external environment. The exemplary embodiment of the dryer ball 10 adopts a closure 40 that engages the receptacle 20 using threads 26. In other embodiments the closure will adopt other means for engaging the body of the dryer ball or other configuration designed as a means for closing the opening through which the ball is filled. These can include a plug or other seal to prevent the inadvertent egress of liquid through the opening into which the dryer ball is filled with liquid. Also contemplated are other mechanisms for sealing the opening including valve-like structures. The closure may be made of various plastic materials such as polyethylene, polypropylene, or polypropylene copolymer. High density polyethylene is a particularly advantageous material for the closure due to its inherent strength and ability to maintain its shape, as well as maintaining the integrity of the product dispensing holes 42.

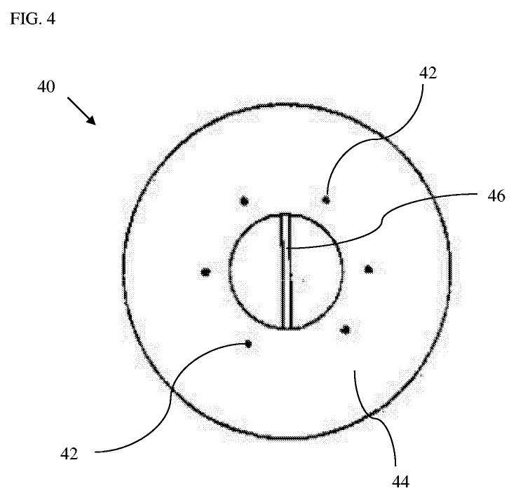

FIG. 4 shows a top plan view of the closure of FIG. 3. The exemplary embodiment of the closure 40 has six product dispensing openings 42 spaced roughly equidistantly about the surface 44 of the closure 40 and distal to the tab 46.

Numerous fluids can be utilized in the present system. A particularly advantageous fluid comprises silicone based fiber relaxers, propyl alcohol, fragrance and glycolic acid. Other liquids, liquid-like substances and gels are possible and do not depart from the spirit of the present invention. A preferred fiber relaxant solution or admixture in accordance with the teachings of the present invention is as follows:

90%* purified water

˜10% N-propyl alcohol

0.002% silicone surfactant (GE Silicones sf1188)

0.001% quaternary amine (Maquat MQ2525-80%)

0.001% fragrance

*all by volume

The present invention further includes a method of removing wrinkles in fabrics using a conventional dryer. The method includes contacting the fabric with a composition comprising water, alcohol and a silicone surfactant using a dryer ball under the action of a tumble dryer. It is found that such a composition has desirable wrinkle-reducing or eliminating properties when combined with the heat and tumbling action of a conventional dryer. To effect the proper temporal release of the composition within the dryer it is found particularly advantageous to employ a dryer ball as disclosed herein.

It will be seen that the objects set forth above, and those made apparent from the foregoing description, are efficiently attained and since certain changes may be made in the above construction without departing from the scope of the invention, it is intended that all matters contained in the foregoing description or shown in the accompanying drawings shall be interpreted as illustrative and not in a limiting sense.

1. A fabric treatment product dispenser comprising:
a hollow receptacle having a product ingress opening adapted to engage a closure and a receptacle surface, the surface being free of product dispensing openings; and
a closure adapted to engage the hollow receptacle and having a closure surface, the closure surface having one or more product dispensing openings;
wherein said fabric treatment product dispenser is adapted to temporally release fabric treatment product responsive to tumbling action imparted upon the product dispenser by a tumble dryer.

2. The dispenser according to claim 1 wherein the shape of the receptacle is selected from the group consisting of spherical, cylindrical and ovoid.

3. The dispenser according to claim 2 further comprising a flat base to facilitate the upright placement of the dispenser on a surface.

4. The dispenser according to claim 1 wherein the receptacle is constructed from a manually squeezable plastic.

5. The dispenser according to claim 1 wherein the receptacle is constructed from a material selected from the groups consisting of polyurethane, polyethylene, and polypropylene.

6. The dispenser according to claim 1 wherein the receptacle is sufficiently translucent to permit the visualization of a product level within the receptacle.

7. The dispenser according to claim 6 further comprising demarcations on the surface of the receptacle to facilitate filling of the receptacle to a desired level.

8. The dispenser according to claim 6 wherein the translucent receptacle is red in color whereby the red color facilitates visualization amongst fabrics.

9. The dispenser according to claim 1 wherein the product dispensing openings are holes ranging in size from about 0.2 mm to about 0.6 mm in diameter.

10. The dispenser according to claim 1 wherein the product dispensing openings are holes of about 0.39 mm in diameter.

11. The dispenser according to claim 1 further comprising a soft covering on the external surface of the sphere whereby the covering reduces the noise associated with the sphere contacting the dryer during use.

12. The dispenser according to claim 11 where the outer covering is a removable covering comprising foam rubber.

13. A method of treating a wrinkled fabric to reduce the amount of wrinkling, comprising the step of contacting the fabric with an effective amount of a composition comprising water, alcohol and a silicone surfactant, wherein the composition is released from a dryer ball under the action of a dryer.

14. A method of treating a wrinkled fabric to reduce the amount of wrinkling, comprising the steps of:
providing a fabric treatment product dispenser comprising a hollow receptacle having a product ingress opening adapted to engage a closure and a receptacle surface, the surface being free of product dispensing openings, and a closure adapted to engage the hollow receptacle and having a closure surface, the closure surface having one or more product dispensing openings, wherein said fabric treatment product dispenser is adapted to temporally release fabric treatment product responsive to tumbling action imparted upon the product dispenser by a tumble dryer; and
contacting the fabric with an effective amount of a composition comprising water, alcohol and a silicone surfactant, wherein the composition is released from the fabric treatment product dispenser.
